(19) United States
(12) Patent Application Publication
(10) Pub. No.: US 2024/0286906 A1
(43) Pub. Date: Aug. 29, 2024

(54) Recycled Graphite for Li-Ion Batteries

(71) Applicants: Mexichem Fluor Inc., St. Gabriel, LA (US); Ascend Elements, Inc., Westborough, MA (US)

(72) Inventors: Rakan Ashour, Waltham, MA (US); Karthik Venkataraman, Waltham, MA (US)

(73) Assignees: Mexichem Fluor Inc., St. Gabriel, LA (US); Ascend Elements, Inc., Westborough, MA (US)

(21) Appl. No.: 18/427,359

(22) Filed: Jan. 30, 2024

Related U.S. Application Data
(63) Continuation-in-part of application No. 18/114,488, filed on Feb. 27, 2023.

(51) Int. Cl. C01B 32/215; B09B 3/70; H01M 10/54; B09B 101/16

(52) U.S. Cl. CPC C01B 32/215; B09B 3/70; H01M 10/54; B09B 2101/16; C01P 2006/11; C01P 2006/12; C01P 2006/80

(57) ABSTRACT

A method to recycle graphite from lithium and sodium-ion batteries. Graphite from the batteries first is treated in an aqueous solution of strong base at a temperature range between about 100° C. and about 250° C., a pressure range between about 0.9 bar and about 20 bar, at a solid-to-liquid ratio of from about 1-to-1 to about 1-to-4. The treated graphite is then washed, filtered, and then treated with a mineral acid (e.g., hydrochloric acid). The purified graphite is then coated with amorphous carbon at a weight percentage range between 0.5 wt % and about 20 wt %. The recycled graphite yielded by the method routinely achieves a purity >99.9%, a specific area of less than or equal to about 10 m²/g.

### CROSS-REFERENCE TO RELATED APPLICATIONS

This is a continuation-in-part of co-pending application Ser. No. 18/114,488, filed Feb. 27, 2023, which is incorporated herein by reference.

### BACKGROUND

Lithium-ion (Li-ion) batteries are a preferred chemistry for secondary (rechargeable) batteries in high discharge applications such as electrical vehicles (EVs) and power tools where electric motors are called upon for rapid acceleration. Li-ion batteries include a charge material, conductive powder and binder applied to or deposited on a current collector, typically a planar sheet of copper or aluminum. The charge material includes anode material, typically graphite or carbon, and cathode material, which includes a predetermined ratio of metals such as lithium, nickel, manganese, cobalt, aluminum, iron and phosphorous, defining a so-called “battery chemistry” of the Li-ion cells. The preferred battery chemistry varies between vendors and applications, and recycling efforts of Li-ion batteries typically adhere to a prescribed molar ratio of the battery chemistry in recycled charge material products. A purity of the constituent products is highly relevant to the quality and performance of the recycled cells, often relying on so-called “battery grade” materials, implying a 99.5% purity.

### SUMMARY OF THE INVENTION

Disclosed herein is a method for recycling graphite for use as anode material in Li-ion batteries. A first version of the method includes treating the impure graphite with an aqueous solution comprised of sodium hydroxide for a time, at specified temperature and pressure to extract a first portion of impurities; and then treating the graphite with a second aqueous solution comprising hydrochloric acid for a time and at a temperature to extract a second portion of metals and oxides from the impure graphite. The purified graphite is optionally coated with amorphous carbon with weight percentage and heat treated for a time and temperature.

Configurations herein are based, in part, on the observation that the increase in popularity of electric and hybrid vehicles (EV/HV) generates a large volume of spent Li-ion batteries including charge material such as NMC (Ni, Mn, Co) cathode material, and anode material including graphite and similar carbon forms. Recycling processes for NMC charge material performs leaching of the spent NMC charge material, often with augmentation using control (virgin) stock of the Ni, Mn, Co salts to achieve a predetermined ratio of the charge material metals according to technical or customer specifications. Graphite from the spent Li-ion batteries can also be recovered. Unfortunately, conventional approaches to NMC recycling suffer from the shortcoming that particles of recovered graphite have impurities, most notably aluminum oxide, remaining as residue after the shredding and leaching process. It can be problematic to satisfy customer specifications for performance and physical anode material characteristics when substantial quantities of impurities remain in the recycled graphite product. Accordingly, configurations herein substantially overcome the shortcomings of conventional battery recycling by producing anode material including graphite with improved purity, at or above 99.5% purity.

In further detail, in a battery recycling environment for producing purified graphite for battery anode material, recycling includes leaching a black mass of exhausted lithium-ion batteries to obtain a leach solution and a precipitate. The leach solution incorporates much of the cathode material, leaving the remainder as undissolved precipitate including substantial proportions of graphite and/or other carbon forms used for the anode material. The low purity graphite typically contains residual Ni, Mn, Co oxides from the cathode, small amount of Cu, Al from the current collectors and Al₂O₃ as a major impurity from separator and/or electrode coating.

Aqueous hydroxides, such as sodium (NaOH), are known for their ability to react with oxide impurities such as aluminum oxide (Al₂O₃) and silicon oxide (SiO₂). For example, the Bayer process uses NaOH to extract Al₂O₃ from natural bauxite. See U.S. Pat. No. 382,505 (May 8, 1888) and U.S. Pat. No. 515,895 (Mar. 6, 1894). In graphite recycled from spent batteries, aluminum oxide is a major impurity because it is used extensively as a coating on the separator (and to a lesser extent on the anode). However, other impurities found in graphite from spent batteries include iron, nickel, copper, manganese, lithium and cobalt. These impurities are difficult or impossible to remove from the graphite using NaOH alone.

Therefore, disclosed herein is a method to recycle graphite materials from spent, scrap and manufacturing reject batteries to produce finished anode materials. In the first step, graphite from recycled batteries is treated with an aqueous hydroxide solution for a time and at a concentration, temperature and pressure to remove at least a portion of aluminum oxide and/or silicon oxide from the graphite. Then, in a second step, the hydroxide-treated graphite is treated with a mineral acid (such as hydrochloric acid) to remove at least a portion of any remaining impurities in the graphite. The purified graphite is then coated with amorphous carbon with weight percentage and optionally heat treated.

It is preferred, but not required, that the first aqueous solution comprises from about 10 wt % to about 50 wt % sodium hydroxide. The time temperature and pressure are preferably from about 1 hour to 24 hours, 100° C. and about 250° C., and 0.9 bar to 20 bar. Times, temperatures, and pressures above these ranges, though, are explicitly within the scope of the method.

It is generally preferred, but not required, that the second aqueous solution comprises a concentration of hydrochloric acid (7-37% wt). The time and the temperature of the reaction are preferably from about 1 hour to about 24 hours, and from about 20° C. and about 100° C. Times and temperatures above these ranges, though, are explicitly within the scope of the method.

In another version of the method, the second aqueous solution optionally further comprises an oxidizing agent. Preferred oxidizing agents include nitric acid, hydrogen peroxide, potassium nitrate, sodium nitrate, and the like.

It is preferred, but not required that the amorphous carbon source comprises petroleum pitch and/or coal-tar pitch mixed with the purified graphite in a concentration from about 0.5 to about 20% wt. The heat treatment time and temperature are preferably from about 1 to 24 hours, and from about 600° C. and about 1,500° C.

### Abbreviations and Definitions

All references to singular characteristics or limitations of the disclosed method shall include the corresponding plural characteristic or limitation, and vice-versa, unless otherwise specified or clearly implied to the contrary by the context in which the reference is made. The indefinite articles “a” and “an” mean “one or more.”

The word “about” as applied to a stated value or range of values means+/−10% of the stated value(s). The word “or” is used inclusively and means “and/or.”

All combinations of method steps disclosed herein can be performed in any order, unless otherwise specified or clearly implied to the contrary by the context in which the referenced combination is made.

The method disclosed herein can comprise, consist of, or consist essentially of the essential elements and steps described herein, as well as any additional or optional pre- or post-processing steps, ingredients, components, or limitations described herein or otherwise useful in inorganic chemistry.

The term “mineral acid” refers to acids derived from one or more inorganic compounds. The term explicitly includes, but is not limited to, hydrochloric acid (HCl), hydrofluoric acid (HF), hydrobromic acid (HBr), hydroiodic acid (HI), nitric acid (HNO₃), sulfuric acid (H₂SO₄), phosphoric acid (H₃PO₄), perchloric acid (HClO₄), and boric acid (H₃BO₃). The term “mineral acid” is used synonymously with “strong acid.” Mineral acids are acids that are completely or very nearly completely ionized in a 1 M aqueous solution.

Analogously, “strong base” refers to bases that are completely or very nearly completely ionized in a 1 M aqueous solution. The term “strong base” thus includes, but is not limited to, lithium hydroxide (LiOH), sodium hydroxide (NaOH), potassium hydroxide (KOH), rubidium hydroxide (RbOH), and cesium hydroxide (CsOH).

“DI”=de-ionized.

“NMC” refers to batteries comprising lithium nickel manganese cobalt oxides. “NMC” is synonymous with “Li-NMC,” “LNMC,” and “NCM. These types of batteries comprise mixed metal oxides of lithium, nickel, manganese and cobalt with the general formula LiNiₓMn_{y}Co_{1-x-y}O₂. These materials are commonly used in the anodes of lithium-ion batteries.

### BRIEF DESCRIPTION OF DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of a recycling environment suitable for use with configurations herein.

FIG. 2 is a flowchart of a recycling process as disclosed herein.

FIGS. 3A-3G are examples of results recycled purified graphite.

FIG. 4 is flow chart depicting an exemplary version of the method disclosed herein to yield battery-grade graphite from graphite reclaimed from recycled batteries.

### DETAILED DESCRIPTION OF THE INVENTION

Disclosed herein is a method and approach for recycling batteries such as NMC batteries and sodium-ion batteries. Configurations herein employ NMC battery chemistry as an example, however the disclosed approach may be practiced with any suitable battery chemistry. Li-ion batteries employ a so-called battery chemistry, which defines the types and ratios of metal ions used to form the cathode material. The specific ratio used is set by the manufacturer or specified by the user or recipient of the recycled charge material. Vendors of charge material and charge-material precursors generate charge material products meeting the manufacturers' prescribed specifications. Anode material is almost always carbon or graphite formulations, and the purity and form of the graphite is also set by the manufacturer.

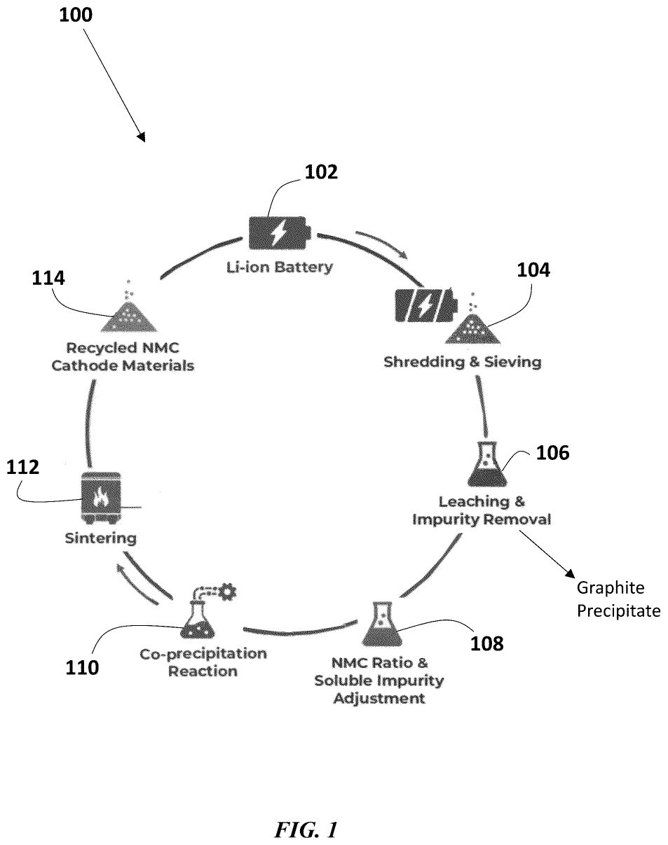

FIG. 1 is a context diagram of a recycling environment suitable for use with configurations herein. Referring to FIG. 1, a recycling scenario 100 begins with a deployed Li-ion battery 102, typically from an EV. Li-ion batteries 102 have a finite number of charge cycles before the ability of the charge material to accept sufficient charge degrades substantially. Add to this the batteries from premature end-of-life due to vehicle failure, collision damage, etc. The collective end-of-life recycling stream contributes to an abundant supply of exhausted batteries comprising spent cells and charge material 104. The batteries are discharged and agitated into a granular black mass through physical grinding, shredding, and pulverizing. A leach process 106 receives the black mass including the charge material and any incidental casing and current collectors of copper and aluminum. The black mass, including both cathode material of comprising metal salts and anode materials comprising carbon and graphite, is used to form a leach solution 106 of dissolved charge material metals.

The leach solution is then separated from the graphite-rich precipitate for harvesting purified graphite, discussed further below, while the leach solution follows a separate recycling branch. For completeness, the leach solution includes at least Ni, Mn and Co in a sulfate solution from sulfuric acid leaching. However, other charge material metals and/or leach acid may be employed. The leach solution 106 has a molar ratio of charge material metals (Ni, Mn and Co) based on the constituent composition of the incoming recycling stream. The molar ratio is adjusted with additional metal salts (Ni, Mn and Co salts), such as sulfate salts (typically a virgin or control form of fresh materials) to yield a target ratio-adjusted solution 108.

A coprecipitation reaction occurs in one or more vessels 110 by adjusting the pH of the leach solution for precipitating the charge material metals (charge materials) in the desired ratio resulting from the adjustment. Sodium hydroxide or another strong base causes the charge material metals, such as NMC, to fall out of solution in a granular form, separable by filtration, typically as hydroxides. This granular form coprecipitated from the pH adjustment of the leach solution is a cathode material precursor, having the desired molar ratio for a target battery chemistry for new, recycled batteries. Sintering in a furnace 112 with lithium carbonate or other lithium salts forms the active cathode material 114 for the recycled Li-ion battery. In an example configuration, active cathode material LiNiₓMn_{y}Co_{z}O₂ is synthesized by sintering NiₓMn_{y}Co_{z}(OH)₂ and Li₂CO₃, where x, y and z represent the respective molar ratios of Ni, Mn and Co. Common chemistries include NMC 111, representing equal molar components of Ni, Mn and Co, NMC 811, NMC 622 and NMC 532. However, any suitable molar ratio may be achieved by the ratio adjustment in the leach solution 106-108 and sintering. The recycled cathode material may then be merged back into the recycling stream as cathode material, while the process below provides the anode material for the recycled battery.

The remaining, post-leach precipitate complements the cathode material recycling by providing a graphite source. Purification of the graphite from spent lithium-ion batteries has been found to be capable of providing anode-quality graphite materials (>99.5%) for lithium-ion batteries. Purification of the graphite precipitate is achieved by an iterative roasting process that is believed to convert water-insoluble metal impurities to water-soluble metal hydroxides, followed by a washing process that is believed to remove these metal hydroxides in the graphite. An optional acid washing process can also be used to produce a further purified recycled graphite.

FIG. 2 is a flow chart showing an exemplary version of the graphite recycling methods as disclosed herein. Referring to FIGS. 1 and 2, leaching of the black mass in step 106 provides a leach solution and a precipitate, which comprises primarily solid, unleached graphite from the battery anodes as well as various impurities. The dissolved cathode materials are leached and carried away by the leach solution, as disclosed at step 202. The undissolved precipitate contains a high percentage of graphite which is ideal for use as recycled anode material, comingled with trace amounts of impurities. The precipitate typically has a purity of from 82% to 97%. The precipitate may further comprise a ceramic impurity, such as an alumina, which is one of the most difficult impurities to remove from the graphite.

The disclosed method of producing purified graphite from the recycled battery stream has been found to remove the impurities efficiently and effectively and commences by sintering the precipitate, as depicted at step 204. This includes preparing a slurry of the precipitate with a first aqueous solution of a hydroxide base having a concentration of a hydroxide of ≤40% by weight, as shown at step 206. The concentration of the first aqueous solution is preferably from 10% to 35% by weight, as depicted at step 208. Most preferred is a concentration of hydroxide base that is 20% to 30% by weight. In a particular configuration, the hydroxide base is NaOH or KOH, as disclosed at step 210. However, any suitable hydroxide may be mixed with the precipitate. For example, the first aqueous solution of hydroxide base is a 7.5M NaOH solution, which is combined with the precipitate while mixing. The combination forms a thick paste, which can be somewhat resistant to mixing. However, a thorough coating of the graphite-containing precipitate is preferably formed.

The slurry of the precipitate is then roasted at a temperature of <250° C. to form a sintered precipitate, as depicted at step 212. In some iterations, roasting at a temperature of from 100° C. to 225° C. may be sufficient, as shown at step 214, including a temperature of from 120° C. to 180° C. Duration of roasting may be for a time of from 1 to 20 hours, depicted at step 216, including from 1 to 15 hours. The roasting time can be adjusted relative to the roasting temperature—higher temperatures can accommodate a lower time (fast roasting) while lower temperatures would benefit from a longer time (slow roasting). During roasting, it is preferable to mix or agitate the roasting slurry, such as about every 40 minutes.

The hydroxide slurry mixing and roasting can be repeated until a predetermined number of iterations or purity threshold is achieved, as depicted at step 218. In most cases, two roasting cycles has been found to be surprisingly efficient at forming battery-grade graphite of at least 99% purity. For example, a slurry of the sintered precipitate resulting from the first iteration can be prepared with a second aqueous solution of hydroxide base having a concentration of a hydroxide of ≤40% by weight. The slurry of the precipitate is then roasted at a temperature of <250° C. to form a sintered graphite. Additional iterations may also be used. For each iteration, the concentrations of the aqueous solutions of hydroxide base and/or the type of base can be the same or different as previous or subsequent iterations. Also, the roasting times and temperatures used in each iteration can be the same or can vary from one another.

In general, the amount of the aqueous solutions of hydroxide base can vary depending on the amount of graphite present. In an example configuration, encompassing two roasting iterations, the slurry of the precipitate has a ratio of the precipitate to the first aqueous solution (first iteration) of about 1:1 to 1:4, and the slurry of the sintered precipitate is formed with a ratio of the sintered precipitate to the second aqueous solution (second iteration) of about 1:1 to 1:4. A different ratio can also be used for each iteration.

It is believed that the sintering forms water-soluble hydroxides, most notably residual hydroxides of the aluminum oxide. Accordingly, in a preferred embodiment, the sintered graphite is washed to form a purified graphite, as shown at step 220. The sintered graphite is typically washed with an aqueous wash solution to reduce the pH to approaching 7, such as between 6 and 10, including between 6 and 8, as depicted at step 222. Washing includes a suitable aqueous solution, including de-ionized (“DI”) water and a weak solution of hydroxide, such as sodium hydroxide, having a lower concentration than solutions used for roasting. Straight water or an aqueous alkaline solution having a concentration of base that is ≤0.1M is also effective. In a specific example, a 0.1M NaOH solution is added to the sintered graphite, stirred for 30 minutes, and then filtered using vacuum filtration. The resulting filter cake of the washed graphite can be further washed using water, particularly with hot or boiling DI water with stirring until the temperature cools to room temperature. DI water washing can be repeated multiple times until a pH of approximately 7 is achieved. After the final wash and filtration, the filter cakes can be dried, such as in a convection oven at 140° C. overnight using a drying sheet.

An enhancement to the present method includes, after washing the sintered graphite with the aqueous wash solution, further washing with an acidic wash solution, as disclosed at step 224. The acidic wash solution may comprise HCl or sulfuric acid, as depicted at step 226. As an example of an HCl wash, 20 g of roasted graphite in a 500 mL glass beaker was combined with 20 ml of concentrated HCl (36.5%), and the combination was stirred for 1 hour to form a homogeneous dispersion. Alternatively, more dilute concentrations of acid can be used, such as a 9% or an 18% HCl solution. The ratio of graphite to acid solution can be between 1:1 and 1:4, such as 1:1 to 1:2 to achieve a final pH that is less than neutral, such as between 5 and less than 7. The washed dispersion is then filtered using vacuum filtration. As with the water/hydroxide wash above, a filter cake form results, to which boiling DI water was added with stirring until the temperature cooled down to room temperature. Multiple acidic washes (three is exemplary) were performed. After the final wash and filtration, the purified graphite filter cakes were dried.

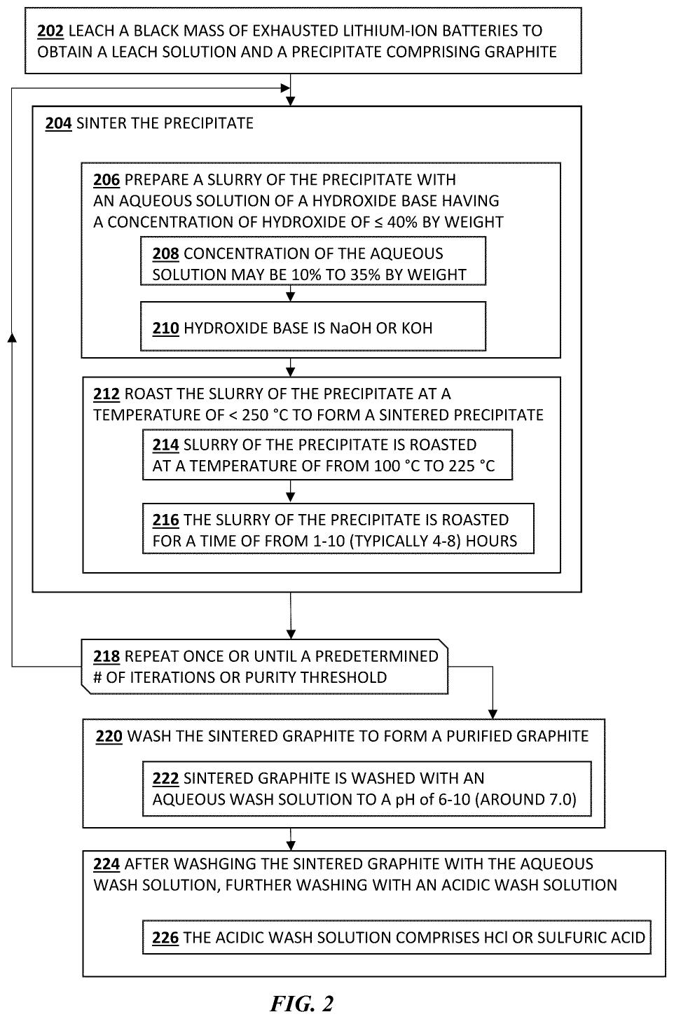

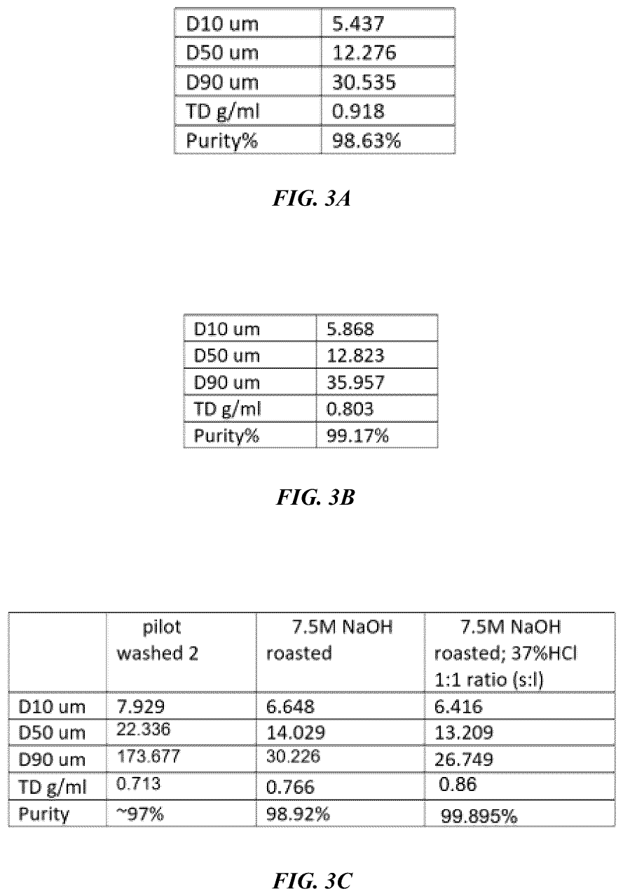

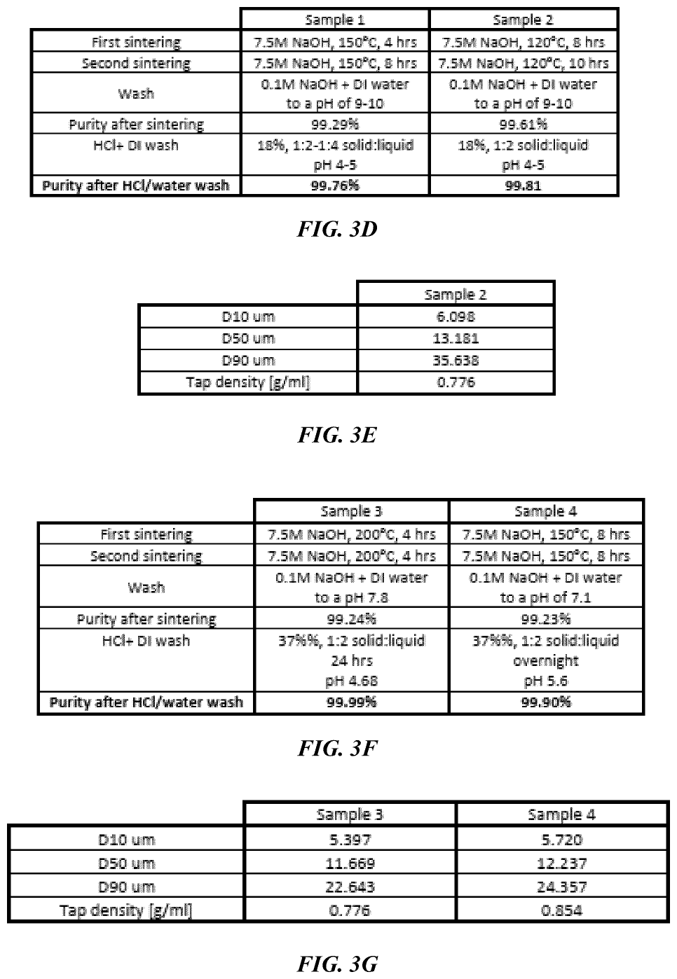

FIGS. 3A-3C are example properties of exemplary purified graphite resulting from the disclosed method, including a particle size distribution (D10, D50, D90), a tap density (TD, measured in gr/mL) and a percent purity. Particle size distributions are commonly represented by multiple values that describe the shape of the distribution curve. In the figures, D10, D50, and D90 values are recorded. D90 describes the particle size at which 90% of the particles have a smaller particle size and 10% have a larger particle size. Similarly, D10 is the size at which 10% of the particles are smaller and 90% are larger. D50 is the 50th percentile particle size in the distribution.

Referring to FIGS. 3A-3C, FIG. 3A an analysis of a purified graphite resulting after a first roasting followed by water washing is shown. The purified graphite was found to have a purity of 98.63% and a particle size distribution similar to a commercially available graphite (D50 between 15 and 25 microns). FIG. 3B depicts results after double roasting (2 iterations of sintering followed by water washing), resulting in a similar particle size distribution and a significantly improved purity of 99.17%. In accordance with the claimed approach, two roasting steps were found to produce higher purity graphite.

FIG. 3C shows three trials corresponding to purified graphite products resulting from different preferred aspects of the disclosed method. In these figures, as can be seen in column 1, a control group, which is a precipitate recovered after leaching of a black mass and subsequently washed with DI water, yields a purity of approximately 97%. In the second column, following two roasting cycles as in FIG. 2 using a 7.5M NaOH solution for each roasting step, and then washing the purified graphite that results after double roasting with DI water produces a purified graphite product having a purity of 98.92%, which is a significant improvement over the control washed graphite. Furthermore, as shown in the third column, by including an additional wash with 37% HCl solution (1:1) followed by a final water wash, an exemplary purity of 99.90% is exhibited in the purified graphite product.

FIGS. 3D and 3E show properties of additional examples of purified graphite products of the present disclosure. As shown in FIG. 3D, two samples of purified graphite were prepared using a double roasting process with a 7.5M NaOH solution for each roasting step followed by washing with a dilute aqueous base (0.1M NaOH solution) and DI water to a pH of 9-10. Sample 1 was prepared by roasting at a temperature of 150° C. for 4 hours and 8 hours while Sample 2 was prepared by roasting at a temperature of 120° C. for 8 hours and 10 hours. After washing, Sample 1 was found to have a high purity value of 99.29%, and Sample 2 had a higher purity of 99.61%. Additionally, inclusion of an HCl/water wash provided further improved purity values of 99.76% and 99.81% respectively. This demonstrates that lower roasting temperatures for slightly longer times can be used to produce purified graphite products having significantly improved purity values. FIG. 3E shows the particle size distribution of Sample 2, which is consistent with those shown in FIGS. 3A-3C, along with an acceptable tap density value.

In addition, FIGS. 3F and 3G show properties of additional examples of purified graphite products of the present disclosure. As shown in FIG. 3F, two samples of purified graphite were prepared using a double-roasting process with a 7.5M NaOH solution for each roasting step followed by washing with a dilute aqueous base (0.1M NaOH solution) and DI water to a pH of less than 8. Sample 3 was prepared by roasting twice at a temperature of 200° C. for 4 hours, and Sample 4 was prepared by roasting twice at a temperature of 150° C. for 8 hours. After washing, Sample 3 and Sample 4 were found to have a purity value of 99.24% and 99.23% respectively. Additionally, inclusion of an HCl/water wash provided further improved purity values of 99.99% and 99.90% respectively. FIG. 3G shows the particle size distribution of Samples 3 and 4, which is consistent with those shown in FIGS. 3A-3C and FIG. 3E, along with an acceptable tap density value.

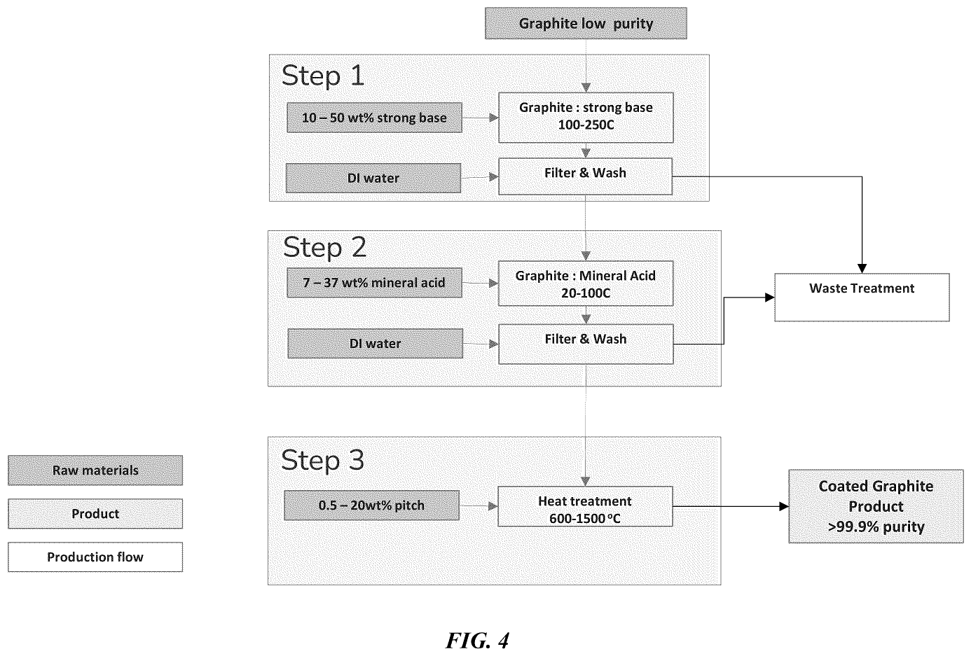

FIG. 4 is a flow chart for another version of the present method. Here, black mass is leached as described earlier. This yields a raw graphite precipitate that is roughly 90 to about 97% graphite, depending upon the feed stock of spent batteries used to make the black mass. The raw graphite is filtered and washed using DI to remove undissolved salts from the cathode extraction process. The graphite is then treated with an aqueous solution comprised of a strong base, such as NaOH (shown), KOH, or a combination thereof. The concentration of the hydroxide solution is in the range of from about 10 to about 50 wt %, and the treatment takes place at a temperature of from about 100° C. to about 250° C., a pressure of from about 0.9 Bar to about 15 Bar, and for a time of from about 1 to about 24 hours.

The graphite is then treated with an acid bath comprised of hydrochloric acid (about 7 to about 37 wt %), optionally mixed with nitric acid (0 to about 65 wt %). The acid treatment takes place at temperatures between about 20° C. and about 80° C., ambient pressure, and for a duration of from about 1 to about 24 hours. The waste process water from the acid treatment step is also shunted to waste treatment tank. The collected wastewater is neutralized by adding appropriate amounts of acid or alkali (depending on the pH of the contents of tank).

After every treatment, the treated graphite is washed with deionized water. The water wash can be performed after each step of purification, or at any point between steps of purification, or after all cycles of purification have been completed. Multiple washings and filtration cycles maybe be performed to ensure that any remaining entrained base or acid is removed from the treated graphite.

The treated graphite is then dried. As shown in FIG. 4, this may be done at 120° C., but any suitable temperature, including ambient, may be used. The resulting graphite has a purity greater than 99.9%.

To restore the low specific area required for battery anode applications, the purified graphite is coated with amorphous carbon from petroleum pitch and/or coal tar pitch.

In one example, recycled graphite with purity <98% was purified using the methods described herein. First, to remove alumina (Al₂O₃) graphite was mixed with an aqueous solution comprised of 25% NaOH and heated to a temperature of 200° C., a pressure of 10 Bar, and a reaction time of 4 hours. The efficiency of alumina removal was tested by measuring the trace elements level in parts per million (ppm) of aluminum before and after the hydroxide reaction. In this example, the level of aluminum dropped from approximately 4000 ppm to less than 10 ppm. The purified graphite from the first step was placed in a second aqueous solution comprised of 37% hydrochloric acid at ambient conditions (room temperature and atmospheric pressure) for 6 hours. The purity of the graphite following the two steps was greater than >99.5% and approaching 99.9%. The trace elements level measurement indicates that all individual impurities in the final graphite dropped below 100 ppm including Al, Ni, Co, Mn, Fe, Cu, and Li.

The purified recycled graphite was then coated with amorphous carbon to reduce the specific area (BET; Brunauer-Emmett-Teller surface area). First, the graphite was mixed with petroleum pitch at a weight percentage of about 11 wt %, and then heat treated to a temperature of around 1000° C. in a controlled atmosphere furnace under nitrogen gas (N₂). The resulting graphite had a specific area less than 1.3 m²/g and a tap density greater than 0.9 g/cm³.

In another example, recycled graphite with purity <98% was purified by another version of the methods described and claimed herein. First, the graphite is placed in an aqueous solution comprised of 25% NaOH and heated to a temperature of 115° C. at atmospheric pressure for 4 hours. After the hydroxide reaction, approximately 99% of alumina was extracted at atmospheric pressure. The purified graphite from the first step is placed in second aqueous solution comprised of 37% hydrochloric acid at ambient conditions (room temperature and atmospheric pressure) for 6 hours. The purity of the graphite following two steps is greater than >99.5% and approaching 99.9%. The trace elements level measurement indicates that all dividual impurities in the final graphite drop below 100 PPM including Al, Ni, Co, Mn, Fe, Cu, and Li.

While the system and methods defined herein have been particularly shown and described with references to embodiments thereof, it will be understood by those skilled in the art that various changes in form and details may be made therein without departing from the scope of the invention encompassed by the appended claims.

1. A method to recycle graphite, the method comprising:
a. treating impure graphite in a first aqueous solution comprising a strong base, for a time, and at a temperature and a pressure to remove a first portion of impurities present in the impure graphite; and
b. treating the impure graphite of step (a) with a second aqueous solution comprising hydrochloric acid for a time and at a temperature to extract a second portion of metals and oxides from the impure graphite to yield purified graphite; wherein the graphite resulting from step (b) has a purity of at least 99%.

2. The method of claim 1, further comprising, after step (b):
c. coating the purified graphite with amorphous carbon to yield coated graphite.

3. The method of claim 1, wherein in step (a) the impure graphite comprises graphite from spent, manufacturing scrap or rejected lithium or sodium-ion batteries.

4. The method of claim 1, wherein in step (a), the first aqueous solution comprises a strong base selected from the group consisting of sodium hydroxide (NaOH), potassium hydroxide (KOH), or mixture thereof.

5. The method of claim 4, wherein step (a) is carried out at a temperature of from about 100° C. to about 250° C.

6. The method of claim 4, wherein step (a) is carried out at a pressure of from about 0.9 bar to about 20 bar.

7. The method of claim 4, wherein step (a) is carried out for a time of from about 1 hour to about 24 hours.

8. The method of claim 4, wherein step (a) is carried out at a solid-to-liquid ratio of from about 1-to-1 to about 1-to-4.

9. The method of claim 4, wherein in step (a), the first aqueous solution comprises about 10 wt % to about 50 wt % strong base.

10. The method of claim 4, wherein in step (a), the first aqueous solution comprises from about 10 wt % to about 50 wt % sodium hydroxide (NaOH).

11. The method of claim 1, wherein in step (b), the second aqueous solution comprises a mineral acid selected from the group consisting of hydrochloric acid (HCl), hydrofluoric acid (HF), hydrobromic acid (HBr), hydroiodic acid (HI), sulfuric acid (H₂SO₄), phosphoric acid (H₃PO₄), perchloric acid (HClO₄), and boric acid (H₃BO₃).

12. The method of claim 11, wherein step (b) is carried out at a temperature of from 20° C. to about 100° C.

13. The method of claim 11, wherein step (b) is carried out for a time of from about 1 hour to about 24 hours.

14. The method of claim 11, wherein step (b) is carried out at a solid-to-liquid ratio of from about 1-to-1 to about 1-to-4.

15. The method of claim 11, wherein in step (b), the first aqueous solution comprises about 10 wt % to about 36 wt % mineral acid.

16. The method of claim 11, wherein in step (b), the first aqueous solution comprises from about 10 wt % to about 36 wt % hydrochloric acid (HCl).

17. The method of claim 1, wherein in step (b) the second aqueous solution further comprises an oxidizing agent.

18. The method of claim 17, wherein the oxidizing agent is selected from the group consisting of nitric acid, hydrogen peroxide, potassium nitrate, and sodium nitrate.

19. The method of claim 1, further comprising step (a)(i): washing the impure graphite with de-ionized water after step (a) and before step (b).

20. The method of claim 19, further comprising, after washing the graphite with de-ionized water, repeating steps (a) and (a)(i) one or more times prior to step (b).

21. The method of claim 1, wherein the resulting graphite comprises no more than about 100 ppm of Ni, Co, Mn, Cu and Cr, no more than about 100 ppm Fe, and no more than about 200 ppm Al.

22. The method of claim 2, wherein in step (c) the purified graphite is coated with amorphous carbon in a weight percentage of from about 0.5 to about 15 wt %.

23. The method of claim 22, wherein the amorphous carbon comprises petroleum pitch, coal tar pitch or mixtures thereof.

24. The method of claim 2, wherein the coated graphite has a specific surface area less than or equal to about 10 m²/g.

25. The method of claim 2, wherein the coated graphite has a tap density from about 0.5 g/cm³ to about 1.5 g/cm³.
